(19) United States
(12) Patent Application Publication
(10) Pub. No.: US 2011/0257990 A1
(43) Pub. Date: Oct. 20, 2011

(54) INTERNET BASED INTERFACE FOR AUTOMATIC DIFFERENTIAL COUNTING AND MEDICAL REPORTING

(76) Inventor: Bryan Dangott, Salt Lake City, UT (US)

(21) Appl. No.: 12/963,616

(22) Filed: Dec. 8, 2010

Related U.S. Application Data
(60) Provisional application No. 61/285,079, filed on Dec. 9, 2009.
(60) Provisional application No. 61/306,538, filed on Feb. 21, 2010.

(51) Int. Cl. G06Q 50/00

(52) U.S. Cl. 705/2

(57) ABSTRACT

An internet based interface program for differential counting and medical reporting includes an internet enabled cell counter, client logic, server logic, and automated report generation. Browser deployed client software interfaces with the user employing a standard keyboard to input data automatically to the cell counting application. Software tallies the data and tracks it for the user to see. Server software, accessed via the internet through the users browser, automatically processes medical counting information data input and reporting parameters, performs counting operations, and generates automated medical reports based on the reporting parameters.

### CROSS-REFERENCE TO RELATED APPLICATIONS

The present utility patent application claims the benefit of provisional application Nos. 61/285,079 filed Dec. 9, 2009 and 61/306,538 filed Feb. 21, 2010.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to differential medical counting and in particular to an internet based interface program for differential counting and medical reporting including an internet enabled cell counter, client logic, server logic, and automated report generation which uses browser deployed client software to interface with the user employing a standard keyboard and mouse to input data to the cell counting application, wherein the software tallies the data and tracks it for the user to see, and server programmed logic software automatically processes medical counting information data input and reporting parameters, performs counting operations, and generates automated medical reports based on the reporting parameters, wherein the server programmed logic software is accessed by a user computing device and browser via the internet.

2. Description of Related Art Including Information Disclosed Under 37 CFR 1.97 and 1.98

Traditional prior art technology makes use of a mechanical counter to perform differential counts. The mechanical technology has no computer interface and no ability to automate reports. This older technology can introduce errors in transcription and calculation that may cause errors in the medical record. Other prior art cell counters consist of digital keypad hardware with an LCD screen. These “keypad” counters have limited customization capabilities and no ability to generate reports. Locally deployed cell counting programs can be used as standalone applications. However, these prior art programs have limited ability to generate reports and cannot be accessed by anyone outside the install site. Some prior art laboratory information system vendors offer rudimentary applications that use a computer based cell counter as an extension of their information system. However, the program is unavailable to those without the “enabled” version of the laboratory information system (LIS). In addition, these prior art systems have limited ability to generate reports.

Prior art US patent applications and patents include the following:
US 2007/0015971 A1
US 2007/0159687 A1
US 2008/0187951 A1
US 2009/0041329 A1
US 2009/0269799 A1
U.S. Pat. No. 4,207,554
U.S. Pat. No. 5,793,969
U.S. Pat. No. 6,789,019 B2
U.S. Pat. No. 7,292,956 B1
U.S. Pat. No. 7,548,830 B2

Prior art foreign patent documents include the following:
DE3503475 (A1) Germany 08-08-1985
EP1953526 (A2) Europe Aug. 6, 2008
WO2006061644 (A1) PCT, 06-15-2006

What is needed is an internet based application which includes an internet enabled cell counter, client logic, server logic, and automated report generation to provide an advance in accuracy, efficiency, and safety over current methods.

### BRIEF SUMMARY OF THE INVENTION

An object of the present invention is to provide an internet based application which includes an internet enabled cell counter, client logic, server logic, and automated report generation to provide an advance in accuracy, efficiency, and safety over current methods.

In brief, the present invention is the first embodiment of an internet deployed cell counter and the first internet deployed counter with automated reporting capabilities. This application uses browser deployed client software to interface with the user. When activated this client software uses a standard keyboard and mouse to input data to the cell counting application. The data is tallied by the client application and tracked for the user to see. When the user completes the cell counting task, the user may choose to send the data to other algorithms for data analysis. These analysis algorithms may reside on the client computer or on a server accessed by the internet. The current embodiment allows for a peripheral blood report template and a bone marrow report template to be generated automatically.

The present invention has advantages over all current methods used for performing differential counts including the following advantages:

The present invention program can be accessed from any computer that is connected to the internet.
Cell counts can be performed using a standard keyboard.
There are no special hardware requirements.
The generated data can be sent to and analyzed by client and server algorithms to generate customized reports for use within the laboratory information system or the electronic medical record.
Error reduction may be achieved because the data is analyzed and the report is generated without the potential for transcription and calculation errors.
Laboratory data in the form of a CBC result can be pasted into an analysis window which can then be combined with the differential count data to perform additional calculations.
Additional calculations may include absolute white count differential, computerized interpretation, or flagging of high or low values.
The report generation tool can integrate and interact with morphology templates including peripheral blood, bone marrow, and cytology specimens templates.
There is a significant time advantage to using the internet deployed application because the data does not need to be dictated, transcribed, or separately calculated.
The counter interface can be used to enter raw data from the traditional manual counters to help with report generation.
The cell counting interface allows miscounted cells to be subtracted.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is an elevational view of a computer screen showing the cell counting application of the present invention having the data tallied by the client application and tracked for the user to see;

FIG. 2 is a is an elevational view of a computer screen showing laboratory data in the form of a CBC result pasted into an analysis window which can then be combined with the differential count data to perform additional calculations.

### DETAILED DESCRIPTION OF THE INVENTION

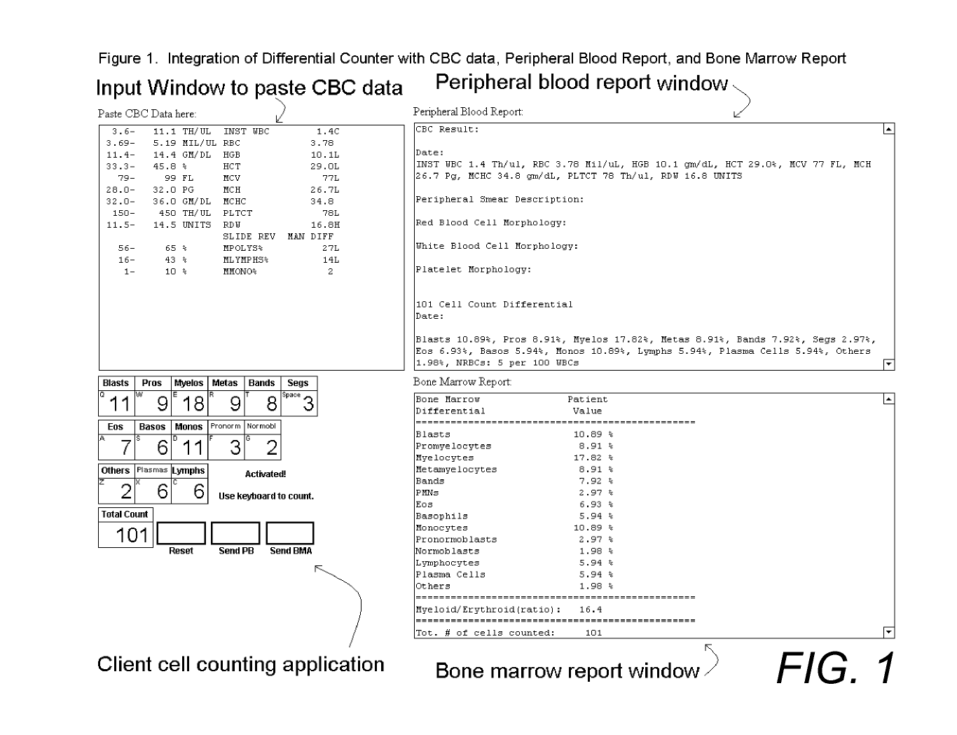

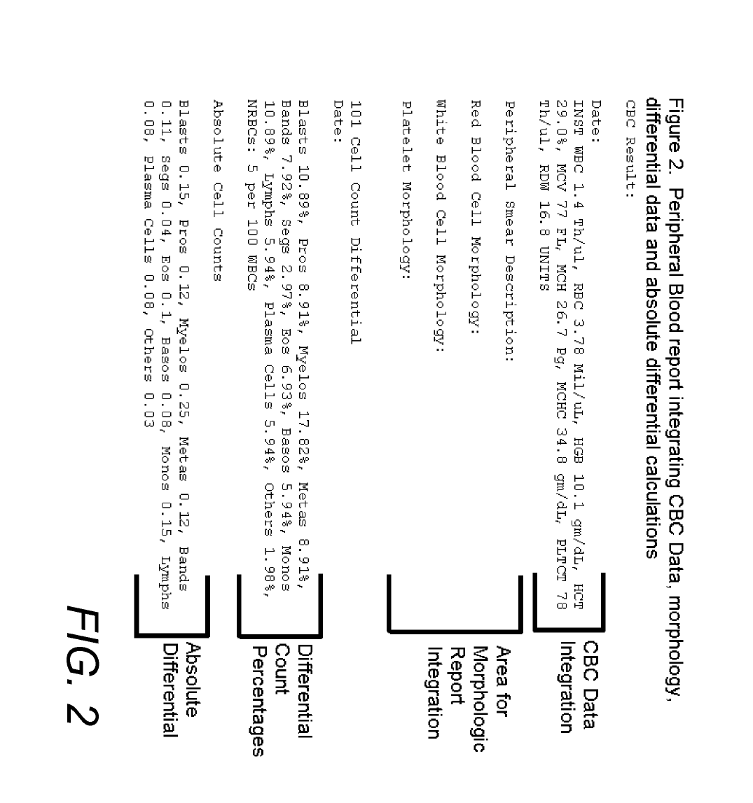

The present invention comprises an automated internet based interface programmed medical system for automatic medical differential counting and medical reporting, with FIGS. 1 and 2 showing computer screen information used in the system. The data is tallied by the client computer based programmed application and tracked for the user to see, as shown in FIG. 1.

The system of the present invention comprises an internet enabled cell counter for use in medical testing and analysis which provides a user computer based programmed component and a server based programmed component.

User programmed logic application software automatically inputs medical information data from medical counting devices and sets reporting parameters. The user programmed logic software is installed on a users computing device having internet access.

Server programmed logic software automatically processes medical counting information data input and reporting parameters, performs counting operations, and generates automated medical reports based on the reporting parameters. The server programmed logic software is accessed by a user computing device via the internet.

The automated internet based interface programmed medical system for automatic medical differential counting and medical reporting of the present invention reduces human error and improves patient safety by automatically making calculations and generating a report without transcription errors and saves time by eliminating dictation and transcription steps.

The internet enabled cell counter comprises an internet enabled differential cell counter used for at least one of the following medical counting procedures taken from the list of medical counting procedures comprising bone marrow cell counting, peripheral blood cell counting, body fluid cell counting, and other medical cell counting procedures.

Further medical counting procedures further comprise absolute white count differential, computerized interpretation, computerized report generation, and flagging of high and low values.

The differential cell counter comprises an automated computer software program and a user internet browser software program for running the differential cell counter program via the user programmed logic application software.

The internet enabled counter sends data automatically and directly to the user programmed logic application software and to the server programmed logic software for automated computer based interpretation and report generation.

The system further comprises a program for calculating and generating a report comprising an analysis window for inputting laboratory data in the form of results of any of a variety of lab tests pasted into the analysis window and combined with the differential count data for performing calculations and generating a report, as shown in FIG. 2.

The system further comprises programmed software means for customizing reports based on user preferences, for generating reports to be integrated into many different laboratory information systems, and for allowing interfacing with any of a variety of existing medical testing and analysis systems.

The system further comprises computer software means for using the input data to automatically generate portions of any of a variety of types of medical reports including a bone marrow report, a peripheral blood report, and a cytology report.

The system is programmed to allow accessing the system from any of a variety of types of computing devices using any of a variety of types of browsers.

The system provides software program means for inputting raw data into the cell counting interface to assist with report generation and software program means to allow the user to subtract cells that were miscounted.

The system is programmed to automatically generate a peripheral blood report template and a bone marrow report template.

The system further comprises computer software means for sending the data to other algorithms for data analysis, wherein the other algorithms for data analysis are programs incorporated in the user programmed logic application software or in the server programmed logic application software.

In use, the present invention can be used by laboratory and clinical personnel to perform cell counts and then automatically generate reports via the internet application. These reports can be customized based on user preferences. Customizations may include but are not limited to content, formatting, and data interpretation. The tool may be used for bone marrow reporting, peripheral blood reporting, cytology reporting, and other medical reports.

The present invention is the first embodiment of an internet deployed cell counter. This is also the first internet deployed counter with automated reporting capabilities. The application of the present invention uses browser deployed client software to interface with the user. When activated this client software uses a standard keyboard to input data to the cell counting application. The data is tallied by the client application and tracked for the user to see (FIG. 1). When the user completes the cell counting task, they may choose to send the data to other algorithms for data analysis. These analysis algorithms may reside on the client or server. The current embodiment allows for a peripheral blood report template and a bone marrow report template to be generated automatically. These templates may incorporate and interact with morphology templates and other interpretive reporting templates.

The technology of the present invention has advantages over all current methods used for performing differential counts. The application of the present invention can be accessed from any computer that is connected to the internet. Cell counts can be performed using a standard keyboard. There are no special hardware requirements. The generated data can be sent to and analyzed by client and server algorithms to generate customized reports for use within the laboratory information system or the electronic medical record. Error reduction may be achieved because the data is analyzed and the report is generated without the potential for transcription and calculation errors. Laboratory data in the form of a CBC result can be pasted into an analysis window which can then be combined with the differential count data to perform additional calculations (FIG. 2). Additional calculations may include absolute white count differential, computerized interpretation, or flagging of high or low values. The report generation tool can integrate morphology templates. There is a significant time advantage to using the internet deployed application because the data does not need to be dictated, transcribed, or separately calculated. The counter interface can be used to enter raw data from the traditional manual counters to help with report generation. In addition, the cell counting interface allows miscounted cells to be subtracted.

It is understood that the preceding description is given merely by way of illustration and not in limitation of the invention and that various modifications may be made thereto without departing from the spirit of the invention as claimed.

What is claimed is:

1. An automated internet based interface programmed medical system for automatic medical differential counting and medical reporting, the system comprising:
an internet enabled cell counter for use in medical testing and analysis;
user programmed logic application software for automatically inputting medical information data from medical counting devices and for setting reporting parameters, the user programmed logic software installed on a users computing device;
server programmed logic software for automatically processing medical counting information data input and reporting parameters, performing counting operations, and generating automated medical reports based on the reporting parameters, the server programmed logic software accessed by a user computing device via the internet, thereby providing an automated internet based interface programmed medical system for automatic medical differential counting and medical reporting to reduce human error and improve patient safety by automatically making calculations and generating a report without transcription errors and to save time by eliminating dictation and transcription steps.

2. The system of claim 1 wherein the internet enabled cell counter comprises an internet enabled differential cell counter used for at least one of the following medical counting procedures taken from the list of medical counting procedures comprising bone marrow cell counting, peripheral blood cell counting, and body fluid cell counting.

3. The system of claim 2 wherein the medical counting procedures further comprise absolute white count differential, computerized interpretation, and flagging of high and low values.

4. The system of claim 2 wherein the differential cell counter comprises an automated computer software program and further comprising a user internet browser software program for running the differential cell counter program via the user programmed logic application software.

5. The system of claim 1 wherein the internet enabled counter sends data automatically and directly to the user programmed logic application software and to the server programmed logic software for automated computer based interpretation and report generation.

6. The system of claim 1 further comprising a program for calculating and generating a report comprising an analysis window for inputting laboratory data in the form of results of any of a variety of lab tests pasted into the analysis window and combined with the differential count data for performing calculations and generating a report.

7. The system of claim 1 further comprising means for customizing reports based on user preferences.

8. The system of claim 1 further comprising means for generating reports to be integrated into many different laboratory information systems.

9. The system of claim 1 further comprising means for allowing interfacing with any of a variety of existing medical testing and analysis systems.

10. The system of claim 1 further comprising means for using the input data to automatically generate portions of any of a variety of types of medical reports including a bone marrow report, a peripheral blood report, and a cytology report.

11. The system of claim 1 further comprising means for accessing the system from any of a variety of types of computing devices using any of a variety of types of browsers.

12. The system of claim 1 further comprising means for inputting raw data into the cell counting interface to assist with report generation.

13. The system of claim 1 further comprising means to allow the user to subtract cells that were miscounted.

14. The system of claim 1 further comprising means for automatically generating a peripheral blood report template, a bone marrow report template, and a cytology report template.

15. The system of claim 1 further comprising means to integrate and interact with morphology templates.

16. The system of claim 1 further comprising means for sending the data to other algorithms for data analysis.

17. The system of claim 16 wherein the other algorithms for data analysis are programs incorporated in the user programmed logic application software.

18. The system of claim 16 wherein the other algorithms for data analysis are programs incorporated in the server programmed logic application software.
